(19) United States
(12) Patent Application Publication
(10) Pub. No.: US 2021/0292193 A1
(43) Pub. Date: Sep. 23, 2021

(54) WATER PURIFYING APPARATUS AND METHOD

(71) Applicant: VWS (UK) LIMITED, High Wycombe (GB)

(72) Inventors: Nigel Philip EMERY, Monks Risborough (GB); John Andrew WALKER, Caversham Berkshire (GB); Martin BALL, High Wycombe (GB); Craig Stephen OVER, High Wycombe (GB)

(73) Assignee: VWS (UK) LIMITED, High Wycombe (GB)

(21) Appl. No.: 17/267,380

(22) PCT Filed: Aug. 12, 2019
(86) PCT No.: PCT/GB2019/052259

§ 371 Date: Feb. 9, 2021

(30) Foreign Application Priority Data
Aug. 15, 2018 (GB) 1813339.7

(51) Int. Cl. C02F 1/32; C02F 1/00; C02F 1/44

(52) U.S. Cl. CPC C02F 1/325; C02F 1/003; C02F 2103/04; C02F 1/444; C02F 1/441; C02F 1/004

(57) ABSTRACT

There is described a water purifying apparatus comprising: (i) at least one water inlet; (ii) an ultra-violet (UVC) radiation chamber connected to the water inlet(s); (iii) a plurality of UVC light emitting diodes (UVC-LEDs) for the emission of UVC light into the radiation chamber; (iv) a control to operate UVC-LEDs in use, and (v) at least one UVC-LED aging monitor to provide feedback to the control.

The present invention relates to a water purifying apparatus and method, particularly but not exclusively for UVC-purifying laboratory and medical grade water, and to a water purification unit containing the water purifying apparatus.

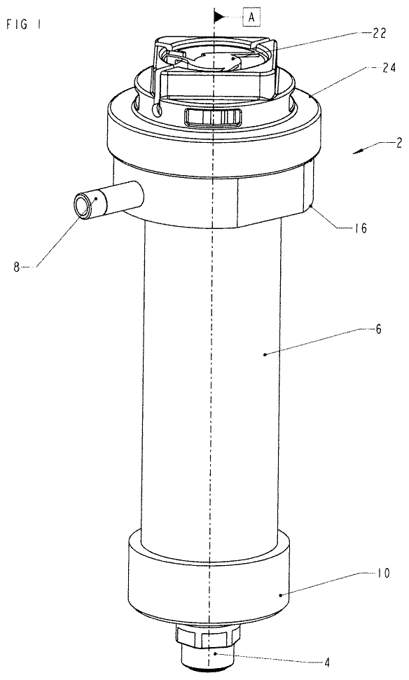

Water purification apparatus and units for use in laboratories and healthcare facilities are well known. Generally, they involve the reduction and/or removal of contaminants and impurities to very low levels. They typically contain a variety of technologies that aim to remove various particles, colloids, bacteria, ionic species and organic substances and/or molecules. An example is shown in FIG. 1 of WO03/076342A1.

In addition, the control of micro-organisms in water purification units, systems and apparatus is a challenge to the designers of such equipment to produce pure water. Within the equipment, several techniques/technologies are utilised to control or eliminate micro-organisms and/or biologically active cell products and debris such as endotoxins and nucleases from the water. These technologies can include reverse osmosis, ultrafiltration, micro-filtration, fluorescent UVC irradiation, etc. In addition to these, recirculation techniques are also employed so that the product water purity is maintained, as well as sanitisation techniques to remove bacterial contaminations from any surfaces within the water purification units, systems and apparatus.

The use of ultraviolet light in the treatment of water is well known in the art and utilises ultraviolet light with wavelength less than 280 nm, i.e. ultraviolet C light, commonly abbreviated to “UVC”.

It is known that ultraviolet light with a wavelength at around 250-280 nm is able to inactivate bacteria and viruses by breaking the dimers in the DNA and hence prevents their replication.

It is also known that ultraviolet light with shorter wavelengths, such as around 180-190 nm, is able to decompose many organic compounds and substances that are contained or are residues in generally available water, by oxidising them to form ionic species which can be subsequently removed from the water by other technologies.

Conventional ultraviolet light sources typically involve emitting ultraviolet light at 254 nm from one or more UVC longitudinal fluorescent tubes in an area or space through which the water passes. The lifetime of fluorescent tubes is limited. They take a relatively long time to start, and each start reduces the life and effectiveness of their ability to produce UVC light. They also operate only in either ‘on’ or ‘off’ states, with little control inbetween.

Also known is the use of UVC-LED sources. The adaptability of UVC-LED units allows them to be more flexible in their location, being smaller and more robust than fluorescent tubes, and therefore be more useable in practice in and around any relevant part of a water purification apparatus. They produce UVC radiation much faster when required than fluorescent tubes, and are not limited by the number of times they are switched on. The amount of UVC radiation emitted can be varied by altering the forward voltage being applied or by pulse width modulation. Examples of their targeted use can be found in WO2011/055133A.

An object of the present invention is to provide an improved water purification apparatus using UVC.

Thus, according to one aspect of the present invention, there is provided a water purifying apparatus comprising:

(i) at least one water inlet;

(ii) an ultra-violet (UVC) radiation chamber connected to the water inlet(s);

(iii) a plurality of UVC light emitting diodes (UVC-LEDs) for the emission of UVC light into the radiation chamber;

(iv) a control to operate UVC-LEDs in use, and

(v) at least one UVC-LED aging monitor to provide feedback to the control.

According to another aspect of the present invention, there is provided a water purifying unit comprising one or more water dispense outlets, a water purifying apparatus as defined herein, and further comprising one or more of the group comprising; pumps, meters, oxidisers, de-ionisers, valves, sensors, drains, controllers, control units and mechanisms, taps, filters, membranes; and able to provide a purified water stream having a conductivity of less than 1 μS/cm, preferably less than 0.1 μS/cm at 25° C. and an organic species content of less than 500 ppb of total organic carbon (TOC), preferably less than 50 ppb.

According to another aspect of the present invention, there is provided a water purifying unit comprising one or more UVC-LEDs located at or around a point of dispense of one of the water dispense outlets.

According to another aspect of the present invention, there is provided a method of providing purified water comprising at least the step of:
passing water through a water purifying apparatus as defined herein.

Optionally, the method further comprises the steps of;
noting a failing UVC-LED; and
activating a previously unused UVC-LED to replace the failing UVC-LED.

The present invention encompasses all combinations of various embodiments or aspects of the invention described both herein above and herein after. It is understood that any and all embodiments and aspects of the present invention may be taken in conjunction with any and all other embodiments and aspects, to describe additional embodiments of the present invention. Furthermore, any elements of an embodiment may be combined with any and all other elements for many of the embodiments to describe additional embodiments.

Embodiments of the present invention will now be described by way of example only, and with reference to the accompanying diagrammatic drawings in which:

FIG. 1 is a perspective view of a water purifying apparatus according to one embodiment of the present invention;

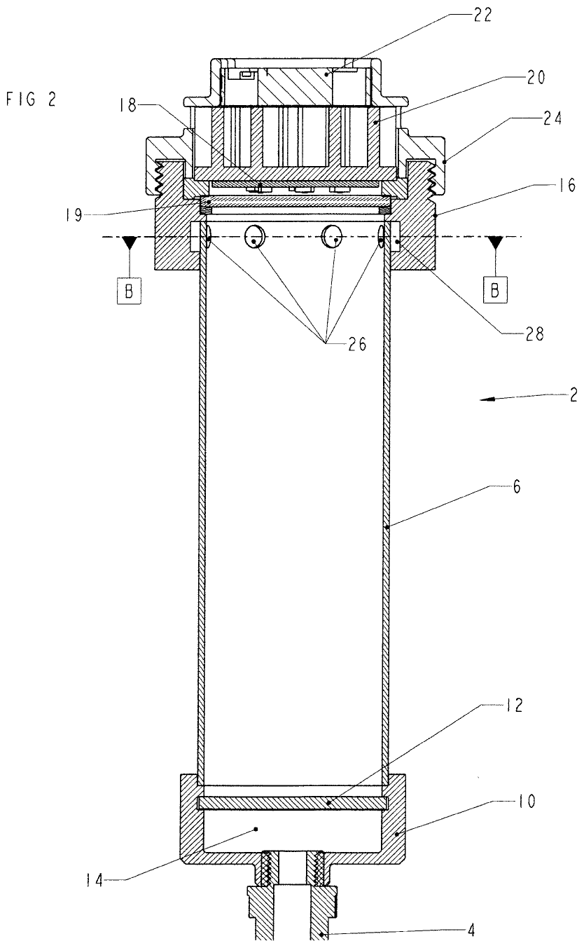

FIG. 2 is a vertical cross-sectional view of the apparatus of FIG. 1 along line AA;

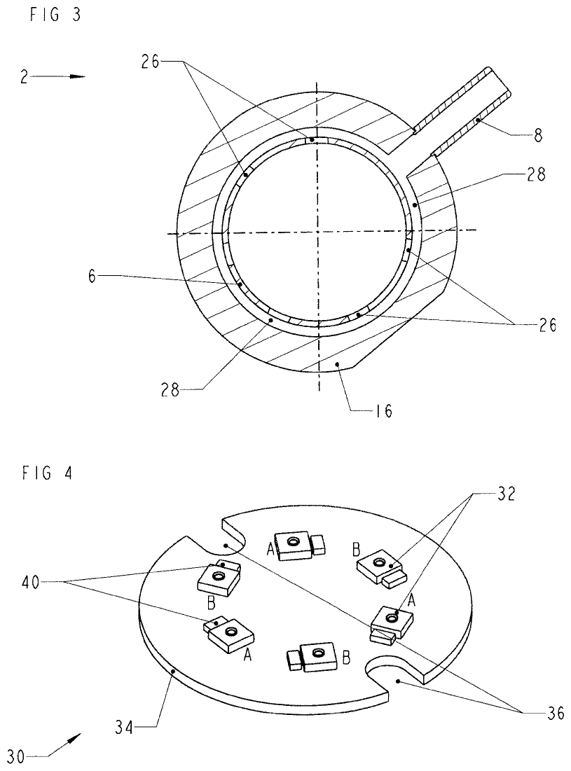

FIG. 3 is a horizontal cross-section view of the apparatus of FIG. 2 along line BB;

FIG. 4 is a perspective view of a first configuration of a UVC assembly useable in the apparatus of FIGS. 1 and 2;

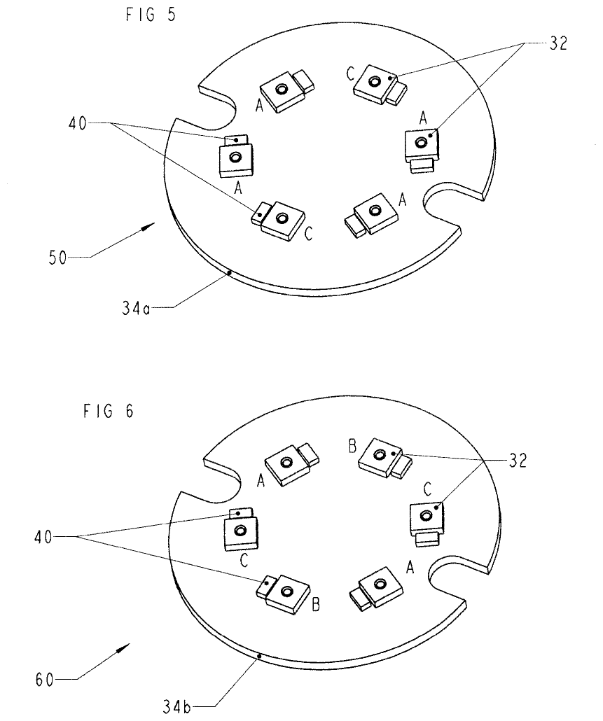

FIG. 5 is a perspective view of a second configuration of a UVC assembly useable in the apparatus of FIGS. 1 and 2;

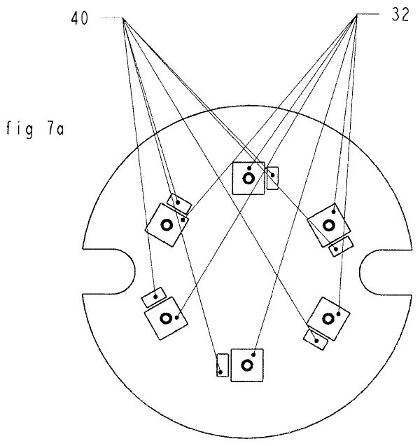

FIG. 6 is a perspective view of a third configuration of a UVC assembly useable in the apparatus of FIGS. 1 and 2;

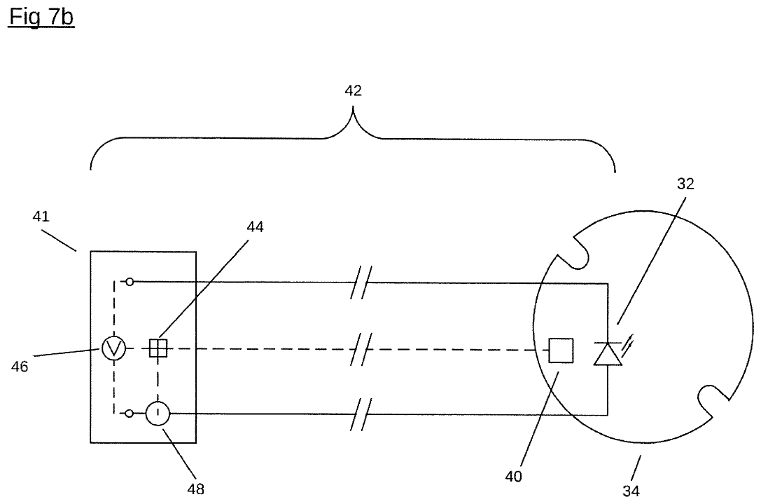

FIG. 7a is a diagrammatic explanation of the printed circuit board of FIG. 4-6;

FIG. 7b is a diagrammatic scheme of an aging monitor and circuity therefor for use in the apparatus of FIGS. 1 and 2;

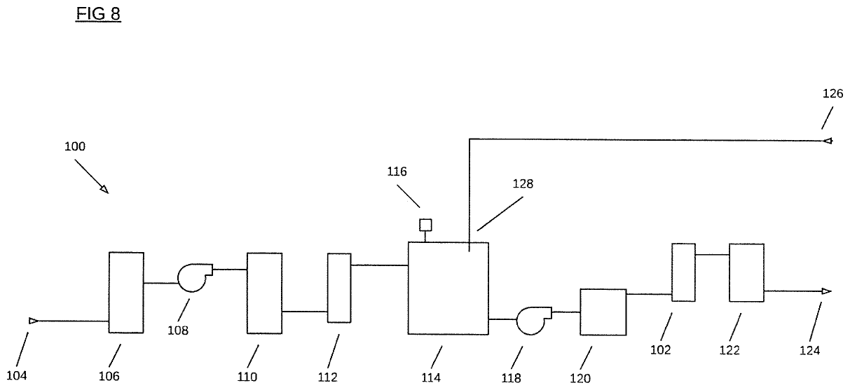

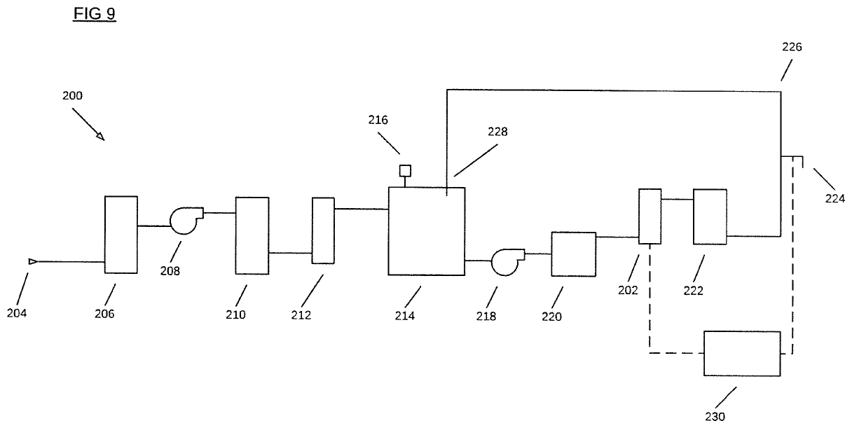

FIG. 8 is a schematic flow of a first water purification unit and method according to further embodiments of the present invention; and

FIG. 9 is a schematic of a second water purification unit and method according to further embodiments of the present invention.

Water purification units are known in the art, and are generally intended to provide purified, further-purified and/or ultra-purified water, optionally having a conductivity of less than 1 μS/cm, preferably less than 0.1 μS/cm, more preferably less than 0.067 μS/cm, at 25° C. This can be equated to a purified water stream having a resistivity of at least 1 MΩ-cm, preferably at least 10 MΩ-cm, more preferably at least 15 MΩ-cm. Additionally, purity specifications can be made for organic species to content levels of less than 500 ppb of total organic carbon (TOC), preferably less than 50 ppb; bacteria to levels less than 100 colony forming units (cfu) per millilitre, preferably less than 1 cfu/ml; and for dissolved oxygen and/or particles.

A water purifying unit may include one or more water purification devices selected from the non-limiting group comprising: a degassing membrane, a reverse osmosis membrane, an ion exchange deioniser, an electrodeionisation device, a capacitive deionisation device, activated carbon, an oxidiser, an ultra-violet device, a UVC-LED device, a particle filter, a microfilter, an ultrafilter, an ozone device and a peroxide device.

A water purifying unit may comprise any number of water purification components, as well as other devices, parts, lines, etc., including but not limited to one or more of the following: pumps, meters, oxidisers, de-ionisers, valves, sensors, drains, controllers, control units and mechanisms, taps, filters, membranes. Generally, the water purification component(s) operate through a controller in the water purification unit to control one or more aspects or processes of the water purification. One or more controllers may be located in the unit.

A water purification unit could be a fixed, permanent or a ‘stand alone’ unit, and generally require connection to nearby water and electricity supplies to be operable. They are generally units operating in or at a specific location such as a laboratory.

One common water purification device involves the use of ultraviolet light, and the ultraviolet treatment of water for microbiological deactivation and/or decomposing organic compounds or substances in water is well known in the art. Apparatus and instruments for providing suitable ultraviolet light are well known in the art, and typically involve emitting ultraviolet light at one or more specific wavelengths less than 280 nm, i.e. ultraviolet C light or ‘UVC’, in an area or space through which the water passes.

Examples of water purifying units using UVC-LEDs are shown in EP2999669A, U.S. Pat. No. 9,617,171B, and WO2006/068979A.

Ultraviolet light with a wavelength around 250-280 nm is able to inactivate bacteria and viruses by breaking the dimers in the DNA, which prevents their replication.

Ultraviolet light with a wavelength around 180-190 nm is able to decompose many organic compounds and substances that are contained or are residues in generally available water, by oxidising them to form ionic species.

A water purifying UVC unit can be provided as a distinct component through which the water stream passes from an inlet to an outlet, the water passing through a region or volume into which a UVC emitter provides UVC radiation.

Optionally, the UVC-LEDs are located on an electrical circuit board, which together can form a UVC assembly.

One example of an electrical circuit board is a printed circuit board (PCB), but the invention is not limited thereto.

When a forward voltage is applied across the junction of the LED forward current flows through the LED and electrical power is dissipated as both light and heat. UVC-LEDs dissipate power as heat, and thermal management of the heat is crucial to the performance and longevity of operation of the UVC-LEDs, as excess heat has a negative impact on both light output and lifetime. It is therefore preferable to use a circuit board having a metal core, preferably an aluminium core PCB. The amount of UVC radiation emitted can be varied by altering the forward voltage being applied and this will have a parallel effect on the amount of heat being generated.

Optionally, the electrical circuit board is at least partly, substantially or wholly reflective, by the addition of one or more UVC reflective materials thereon, to assist the reflection of UVC light into the radiation chamber.

Alternatively, the PCB is a metal core PCB, preferably an aluminium core PCB, and part of the dielectric layer is removed to reveal the aluminium layer. Aluminium has a high reflectivity to UVC radiation so the removal of part of the dielectric layer where there are no components revealing the base aluminium will allow some of the UVC radiation that would otherwise be absorbed by the dielectric layer to be reflected into the UVC radiation chamber.

Optionally, the UVC-LEDs are located in an array. The array could be symmetrical or non-symmetrical, optionally based on having a symmetrical arrangement around an electrical circuit board. Where the electrical circuit board is circular or the radiation chamber into which they emit is circular, this could include a symmetrical array in a clock like fashion around the centre of the electrical circuit board for the UVC-LEDs. Optionally the array comprises arranging the UVC-LEDs into one or more series, rows or columns, groups, sets or patterns, optionally intended to provide an even distribution of UVC light from the array, but not limited thereto.

One embodiment of the present invention is to provide more UVC-LEDs, (optionally termed ‘secondary/back-up/other/second/excess/reserve’ etc., UVC-LEDs), than the required UVC light output to treat the maximum fluid capacity of the radiation chamber, and in this way have at least one, optionally more than one, UVC-LED in reserve, or otherwise being wholly or substantially passive during the activity of other UVC-LEDs, wherein such additional UVC-LEDs may be operational or useable following the reduction or failure in power of one of the first/initial UVC-LEDs.

Any such extra or additional UVC-LEDs may be arranged within any symmetrical array of all the UVC-LEDs, or may be arranged in an extra or additional location or position, which allows the activity of the extra or additional UVC-LED to continue to maintain, as far as possible, an equality or evenness of UVC-LED radiation into the radiation chamber when in use.

In one example of the present invention, one or more of the UVC-LEDs could be located centrally in any circular or area-based arrangement of other UVC-LEDs in a first array, such as being circular around a circular electrical circuit board.

Optionally or additionally a UVC-LED from a set of UVC-LEDs that would not otherwise be operating at that time when the failing UVC-LED would be operating can be activated. Where more than one UVC-LED can be operated, then the actual UVC-LED operated can be selected in a regular, rotational or random manner.

Optionally, the apparatus of the present invention comprises any number of UVC-LEDs. Optionally, the apparatus comprises at least two, three, four, five or six UVC-LEDs, and optionally a maximum of six, eight, ten, twelve, fifteen or twenty LED. Optionally, the apparatus comprises 2-12 UVC-LEDs, optionally being four, five, six, seven or eight UVC-LEDs.

Optionally, there are 2-12 UVC-LEDs, optionally 4-8 UVC-LEDs, such as 6 UVC-LEDs.

Optionally, the UVC-LEDs are arranged in to at least two sets, series, rows or columns, groups, or patterns of UVC-LEDs. Each set et al may have the same or different number, type or symmetry of UVC-LEDs. Each set et al may be separate, separately controllable, separately operable, etc. In forming such sets et al, there is formed at least a set of first UVC-LEDs, and a set of second UVC-LEDs

Optionally, the present invention includes a set of three first UVC-LEDs and a set of three second UVC-LEDs. Other arrangements include, but are not limited to, a set of four, five or six first UVC-LEDs and a set of two, three or four second UVC-LEDs; or a set of two first UVC-LEDs, a set of two second UVC-LEDs, and a set of two third UVC-LEDs; or a set of two or more first UVC-LEDs, a set of two or more second UVC-LEDs, and a set of one or more third UVC-LEDs; or a set of three or more first UVC-LEDs and a set of three or more second UVC-LEDs, and a set of two or more third UVC-LEDs. The skilled person can see other possible arrangements.

Optionally, the control alternates the use of each set of UVC-LEDs, or at least alternate between at least two sets of more than two sets of UVC-LEDs.

The term “control” as used herein relates to any control or control means known in the art, able to control the operation of one or more of the UVC-LEDs, generally but not limited to being part of the LED circuitry, and typically but not limited to including control or controlling software known in the art, and optionally including one or more semi-conductors and/or CPUs.

The present invention can include an electronic switch or switch means or switching gear, generally controlled by the control, and able to provide the method of switching individually or between the UVC-LEDs, typically at the request of the control.

The apparatus of the present invention includes at least one UVC-LED aging monitor. An aging monitor is able to monitor at least the temperature and a power characteristic, including for example power input or output, of a UVC-LED. The control is able to characterise the operation of a UVC-LED based on the feedback provided by an associated ageing monitor, to determine the operational ability of the UVC-LED, optionally over time, i.e. its ‘ageing’, and in particular whether the UVC-LED is sufficiently operable to provide the required UVC into the UVC radiation chamber, or is not, i.e. there is an UVC-LED operational failure.

The aging monitor optionally includes a temperature monitor, e.g. a thermistor, which can be located next to at least one of the UVC-LEDs, optionally at least some of the UVC-LEDs, and optionally next to each of the UVC-LEDs. A temperature monitor is able to monitor the heat dissipation of a UVC-LED in use, and provide either a constant or regular or intermittent signal to the control, to indicate whether the UVC-LED has an operational temperature as expected in order to maintain expected operation in use, or whether a variation in temperature has occurred, either higher or lower, which could indicate an issue or concern concerning the UVC-LED.

The aging monitor optionally includes a separate or combined power monitor, which can be located next to at least one of the UVC-LEDs or as part of its power circuit or circuitry, optionally for at least some of the UVC-LEDs, and optionally for each of the UVC-LEDs. A power monitor is able to monitor a power characteristic such as voltage or current of the power of a UVC-LED in use, and provide either a constant or regular or intermittent signal to the control, to indicate whether the UVC-LED has an operational power usage as expected in order to maintain expected operation in use, or whether a variation in power has occurred, either higher or lower, which could indicate an issue or concern concerning the UVC-LED.

For example, a signal indicating a reduction in temperature from a temperature monitor may indicate a failure, possibly a slow or rapid failure, of the UVC-LED. Similarly, an increase, optionally a slow or fast increase, in temperature reading from a temperature monitor may indicate slow or faster deterioration in the operation of a UVC-LED.

As the UVC-LEDs age through use, the voltage that is required to pass a certain current across the UVC-LED's junction increases and this can be monitored to ascertain ageing of the UVC-LED.

A suitable control or controller monitoring the aging via the voltage required by each UVC-LED and/or each temperature monitored, can either provide a suitable signal to a user, or have suitable automatic control, to consider stopping the use of any such UVC-LED, and optionally considering the introduction of one or more secondary, backup or second UVC-LEDs that are available for use in the apparatus of the present invention or altering the power being applied to one or more particular UVC-LEDs to prevent further deterioration of that UVC-LED or to maintain the overall amount of UVC being applied to the UVC radiation chamber.

Thus, in one regard, a first set of UVC-LEDs could be the initial operational UVC-LEDs, and a second set of UVC-LEDs could be a back-up or support UVC-LEDs

And optionally, the control is able to vary the use of at least a number of the UVC-LEDs, and/or vary the power of at least a number of the UVC-LEDs.

Optionally the control includes one or more switches. Optionally, the switch is able to switch the use of one of the first UVC-LEDs to one of the second UVC-LEDs upon failure of one of the first UVC-LEDs.

Optionally the control is able to increases the power of at least one or more of the UVC-LEDs over time, optionally all of the first UVC-LEDs over time.

Optionally, the aging monitor is associated with each UVC-LED.

Optionally, the or each aging monitor monitors at least temperature and a power characteristic of an UVC-LED.

Optionally, the or each aging monitor is able to monitor the operational lifetime of an UVC-LED.

Optionally, an aging monitor is able to feedback the failure of UVC-LED to the control.

Individually or collectively, the present invention can further include one or more of the group comprising:
a control of the UVC-LEDs.
a switch or switch means to switch operation between the UVC-LEDs.
   a water outlet comprising a series of apertures in the radiation chamber and an endcap able to fit around the apertures to create a collection annulus between the radiation chamber and the endcap to direct water flow from the radiation chamber to a single outlet stream.
   a water inlet comprising a series of apertures in the radiation chamber and an endcap able to fit around the apertures to create a distribution annulus between the radiation chamber and the endcap to direct water flow to the radiation chamber from an inlet stream.
   a sinter filter between the at least one water inlet and the UVC radiation chamber.
   a reflective plate or PCB behind the UVC-LEDs to direct UVC light into the radiation chamber.
   a sinter filter between the at least one water outlet and the UVC radiation chamber.
   one or more further UVC-LEDs, which together with a first set of UVC-LEDs, are able to provide more UVC radiation into the UVC radiation chamber than required for the capacity of the radiation chamber, and a control to limit the simultaneous operation of the number of the UVC-LEDs.

In one view, the present invention relates to water purifying apparatus comprising:
(i) at least one water inlet;
(ii) an ultra-violet (UVC) radiation chamber connected to the water inlet(s);
(iii) a sinter filter between the at least one water inlet and the UVC radiation chamber;
a plurality of UVC light emitting diodes (UVC-LEDs) for the emission of UVC light into the radiation chamber comprising at least:
(iv) one or more first UVC-LEDs;
(v) one or more second UVC-LEDs, which together with the first UVC-LEDs, are able to provide more UVC radiation into the UV radiation chamber than required to treat the maximum fluid capacity of the radiation chamber;
(vi) a control to operate UVC-LEDs in use,
(vii) a series of apertures in the UVC radiation chamber, and an endcap able to fit around the apertures to create a collection annulus between the radiation chamber and the endcap to direct water flow from the radiation chamber to a single outlet stream; and
(viii) at least one UVC-LED aging monitor to provide feedback to the control.

The method of the present invention is for providing purified water comprising at least the steps of passing water through a water purifying apparatus as defined herein. Optionally, the method further comprises controlling the alternate use of sets of first and second UVC-LEDs. Optionally, the method further comprises a plurality of operational UVC-LEDs and at least one support UVC-LED, and operating at least one support UVC-LED upon the failure of any of the operational UVC-LEDs. Optionally, the method further comprises varying the use of one or more of the UVC-LEDs, and/or increasing the power of at least one or more of the UVC-LEDs over time

Optionally, in the method of the present invention, the apparatus comprises a set of two or more first UVC-LEDs and a set of one or more second UVC-LEDs, which together with the first UVC-LEDs, are able to provide more UVC radiation into the UVC radiation chamber than required to treat the maximum fluid capacity of the radiation chamber, the method further comprising limiting the simultaneous operation of the number of the UVC-LEDs.

Optionally, in the method of the present invention, the aging monitor detects operational failure of one or more of the UVC-LEDs and provides feedback to the control, and wherein the control operates one or more UVC-LEDs.

It is confirmed that in the present invention, the number of UVC-LEDs in any one set may or may not equal the number of UVC-LEDs in any one other set. For example, an embodiment of the present invention may comprise a set of any one of 1, 2, 3, 4, 5, 6, 7 or 8 first UVC-LEDs, and independently, a set of any one of 1, 2, 3, 4, 5, 6, 7 or 8 second UVC-LEDs.

The terms “water inlet” and “water outlet” as used herein relate to any form of connection or connection point between the water purifying apparatus of the present invention, and other apparatus, units or devices, usually together forming all or part of a water purifying unit. Such connections or connection points are typically provided by pipes or pipe work, at least one of which is able to provide water to the water purifying apparatus, and at least one of which is able to provide water away from the water purifying apparatus.

The present invention is not limited by the number or nature of the water inlet or inlets, and water outlet or outlets. Preferably, there is a single water inlet and a single water outlet from the water purifying apparatus.

The water purifying apparatus of the present invention may have any suitable shape, size and design, as long as water passing from the at least one water inlet to the at least one water outlet has sufficient engagement with the emission of the UVC light into the radiation chamber to provide the required biological effect.

In one embodiment of the present invention, the apparatus comprises an elongate ultra-violet radiation chamber. Optionally, such an elongate radiation chamber is a cylindrical radiation chamber.

An elongate radiation chamber generally comprises an intermediate body, which can be formed of any suitable material including stainless steel or aluminium, or a number of known plastics including PTFE, optionally having a coating or lining on the internal surface of a reflective material for the reflection of any UVC light that falls onto the surface. Additionally or alternatively, an additive or coating can be applied to the material on the internal surface that assists in the production of oxidising species when UVC is incident upon the surface. One such material is titanium dioxide.

An elongate radiation chamber generally has two ends, and in one embodiment of the present invention, one water inlet is located wholly or substantially at one end, and one water outlet is located wholly or substantially at the opposite end.

Optionally, the present invention further comprises a reflective surface behind the UVC-LEDs to reflect any incident UVC into the radiation chamber. The reflective surface could be formed from one or a combination of known materials, and serves to assist concentration of the UVC light emitted from the UVC-LEDs into the radiation chamber.

Optionally, the present invention further comprises one or more UVC-LEDs able to provide more UVC radiation into the UV radiation chamber than required to treat the maximum fluid capacity of the radiation chamber.

Optionally, the present invention further comprises a series of apertures in the UVC radiation chamber, and an endcap able to fit around the apertures to create a collection annulus between the radiation chamber and the endcap to direct water flow from the radiation chamber to a single outlet stream.

In one embodiment of the present invention, the apparatus comprises a first set of UVC-LEDs and a second set of UVC-LEDs, and the control alternates between each of the first and second sets. The skilled man can see that further sets can be added to this arrangement, and the control can be organised to alternate between any such further sets.

In this way, the apparatus provides an option for one set of UVC-LEDs to be in use, while another set or sets is not in use or otherwise passive. Then, one of such further sets could be operated to be in use, whilst the first set of UVC-LEDs is made passive or inactive. As the activation time for UVC-LEDs is minimal, this time period of operation of each set can be less than 10 seconds, such as 5 seconds. In this way, the conventional operation of all UVC-LEDs continuously is avoided, thereby allowing heat to dissipate away from the UVC-LEDs and hence extending the lifetime of the water purifying apparatus.

Optionally, operation of one or more of the UVC-LEDs or sets of UVC-LEDs may be at a current that is lower than or at a duty cycle of less than 100%, e.g. 40-60%, than the usual or operational maximum for the UVC-LED, to increase lifetime of the water purifying apparatus. This also provides the capability to increase the UVC generation at times of increased biological content of the inlet water either by operation at higher current or by the operation of more UVC-LEDs. When operating more UVC-LEDs the operation may be randomised so that the selection of which UVC-LEDs are operated at any time is varied but when considered over a long period such as the water purifying apparatus's lifetime the use is similar.

The skilled man can see that the present invention provides a range of options to a user to have a number of UVC-LEDs, and to control which UVC-LEDs to use at any one time, either based on having a number of sets of UVC-LEDs and alternating, or by having one or more reserve or backup UVC-LEDs or both, wherein one or more of any second set or additional UVC-LEDs is used as a backup or reserve UVC-LED, in order to continue or extend the operation of the UVC-LED whilst allowing the user time to consider obtaining a new water purifying apparatus as a replacement, or finding a suitable time for repair of the water purifying apparatus, without sudden or catastrophic failure of the water purifying apparatus, and therefore failure of a water purifying unit in total.

Alternatively or additionally, the water purifying apparatus includes a control to vary the use of each UVC-LED. The variation of the use may be variation of the power provided to one or more of the UVC-LEDs, generally to vary the amount or intensity of UVC light provided therefrom. In this way, the control can better or best organise a variation in the operation of two or more UVC-LEDs, to improve the overall operation, optionally the longevity, of the UVC-LEDs.

In one example, the control increases the power of at least one or more of the UVC-LEDs over time. That is, where a UVC-LED is operational for a first time, or an initial period, it is typically able to provide an amount or intensity of UVC light greater than later on in its operational life. Conventionally, UVC-LEDs are simply turned ‘on’, and continue at their maximum power without interruption. Generally, LEDs are known to provide a reduced amount of UVC light over time, as they start to wear out through their usage. In the present invention, controlling the power of the UVC-LEDs to be less at an initial stage or time, and to increase over time, increases the longevity of an UVC-LED, thereby increasing the longevity of the water purifying apparatus of the present invention.

It is known that as well as an even distribution of UVC radiation over the cross sectional area of the UV radiation chamber, it is also beneficial for the water flow to be laminar such that all of the water has as similar an exposure as possible to the UVC radiation.

Thus, according to another embodiment of the present invention, there is provided a series of apertures in the radiation chamber, and an endcap able to fit around the apertures to direct water flow from the radiation chamber to a single outlet stream.

The water purifying apparatus may have any number of radial or lateral apertures, generally arranged in a symmetrical arrangement, and generally at the same or approximate same distance from one end of the radiation chamber. The lateral apertures may have any suitable size, shape and design, intended to ensure correct flow of water for the capacity and desired flow of the radiation chamber. The water passes from the radiation chamber through the apertures into an annulus created between the outside surface of the radiation chamber and the inside surface of the endcap and the water is directed from the annulus and hence the water purifying apparatus by a single outlet connection. Alternatively, water may be flowed from the single connection, now becoming the inlet, through the annulus and apertures into the radiation chamber.

According to another embodiment of the present invention, there is provided a sinter filter between the at least one water inlet and the UVC radiation chamber, or, if the flow through the radiation chamber is reversed, between the UVC radiation chamber and the at least one water outlet.

A sinter filter has a porosity which assists providing a more laminar flow of water therefrom. The filter may be asymmetric such that the body is course with a finer surface layer. The filter may be a material or have a surface layer or coating that is reflective to UVC radiation such as PTFE.

In combination, the present invention can provide a wholly or substantially laminar flow of water from the at least one water inlet to the at least one water outlet. Such a laminar flow will absorb the radiated UVC light more efficiently and more evenly, increasing the effectiveness of the water purification apparatus.

Optionally, the water purifying apparatus as defined herein comprises a water inlet, a water outlet, and a cylindrical ultra-violet (UVC) radiation chamber therein between.

Optionally, the water purifying apparatus as defined herein has the UVC-LEDs located on an electrical circuit board at one end of the cylindrical ultra-violet (UVC) radiation chamber. Optionally, the UVC-LEDs are located on an electrical circuit board at one end of the cylindrical ultra-violet (UVC) radiation chamber beyond the water outlet.

Optionally the present invention further comprises a sintered filter between the at least one water inlet and the UVC radiation chamber.

Optionally, the water purifying apparatus as defined herein has an antechamber after the water inlet and before cylindrical ultra-violet (UVC) radiation chamber.

Optionally, the water purifying apparatus as defined herein comprises a sintered filter is located between the antechamber and cylindrical ultra-violet (UVC) radiation chamber.

According to one aspect of the present invention, there is provided a water purification unit comprising one or more water dispense outlets and a water purifying apparatus as defined herein.

The water purification unit may further comprise one or more of the group comprising; pumps, meters, oxidisers, de-ionisers, valves, sensors, drains, controllers, control units and mechanisms, taps, filters, membranes; and able to provide a purified water stream having a conductivity of less than 1 μS/cm, preferably less than 0.1 μS/cm at 25° C. and an organic species content of less than 500 ppb of total organic carbon (TOC), preferably less than 50 ppb.

Optionally, the water purifying unit further comprises one or more UVC-LEDs located at or around a point of dispense of one of the water dispense outlets.

Optionally, the total power applied to the one or more UVC-LEDs located at or around the point of dispense is <50%, optionally <20%, of the total power applied to all of the operational UVC-LEDs in the water purifying apparatus, i.e. those UVC-LEDs actually operating to provide the effect into the radiation chamber of the water purifying apparatus.

The relatively small size of UVC-LEDs makes it possible to use them to provide local irradiation at various locations in and around a water purification unit, and particularly at a point of dispense (i.e. where the purified water leaves the apparatus), to prevent/inhibit microbial contamination at the air/water interface, during dispense, more particularly during periods of non-dispense.

The decontamination or germicidal effect provided by the water purifying apparatus is useable over any time period or periods, ranging from being permanently active, to intermittent use such as during purified water dispense, and/or intermittently during non-dispense periods of the apparatus. For example, there could be a water purifying apparatus located around the point of dispense of a water outlet which is operational intermittently, usually periodically, during periods of non-dispense of purified water, and automatically active during periods of water dispense.

There could be a water purifying apparatus located around other water parts or passages in or through which water passes, particularly intermittently and/or which are inactive when water is not being dispensed. This can involve ‘stagnant areas’, more likely to give time and space for microbial activity and build up. For example, just after any valve when not dispensing, especially after an outlet valve, or at locations in or around a water storage area or tank, in particular in corners thereof, etc.

Thus, the present invention extends to a component or part of a water purification unit as defined herein, wherein the component comprises one or more of the following: pumps, meters, oxidisers, de-ionisers, valves, pipes, piping, drains, controllers, control units, control mechanisms, outlets, taps, reservoirs, recirculation loops, filters and membranes; having a water purifying apparatus as defined herein, with one or more UVC-LEDs therewith, preferably integrally therewith.

In another aspect of the present invention, there is provided a system for facilitating maintenance of water treatment apparatus as defined herein comprising the steps of:
a. providing multiple UVC-LEDs;
b. operating at least one of the UVC-LED;
c. monitoring the usage of each operational UVC-LED;
d. determining the operational life of each operational UVC-LED; and
e. when the end of the operational life of a UVC-LED is determined, switching the said UVC-LED to another UVC-LED.

Water purification systems generally incorporate several purification technologies to remove ions, organic molecules, particles, gases and microbiological active contaminants. The water purification systems also include pumps valves and reservoirs and typically contain recirculation loops to maintain the water at the highest level of purity. The controls for these processes can be operated by a single or multiple electrical circuit boards.

Optionally, the water purifying apparatus as defined herein is operated in a water purification system containing one or more of: a prefilter to remove particles and dissolved chlorine from the inlet water; a pump to increase the water pressure; one or more reverse osmosis membrane to remove ions and organic molecules; a degassing membrane to remove dissolved carbon dioxide; these processes creating a purified water that is fed to a reservoir that has a vent filter that protects the reservoir's contents by removing carbon dioxide, particles and bacteria from the air that enters the reservoir when the level decreases; a recirculation loop from the reservoir; a pump to deliver and recirculate the water depending upon demand; one or more ion exchange media cartridge to remove trace levels of ions and organic molecules; a UVC water purifying apparatus as defined herein; a fine filter for removing microbiological molecules and a recirculation outlet and a recirculation return. The recirculation outlet and recirculation return allow the ultra-pure water produced to be delivered to one or more places of need or returned to the reservoir in the water purification system when there is no or reduced demand.

Optionally, the water purification system may have a point of dispense such as a valve or tap or faucet on the system. As microbiological growth can occur on surfaces throughout the water purification system it is preferable to include a final UVC purification at this point. It is preferable for this to operate in conjunction with the water purifying apparatus such that they have the same control and control of the UVC-LED water purifying apparatus and the UVC point of dispense is operated and adjusted by the same control system. It is also preferable for the power to the UVC-LED point of dispense to be lower than to the UVC-LED water purifying apparatus, preferably <50% or <20% of the power, to avoid heating the dispensed water.

Referring to the figures, FIGS. 1, 2 and 3 fully or partly show a water purifying apparatus 2 according to one embodiment of the present invention, comprising a water inlet 4, an ultra-violet radiation chamber 6, and a water outlet 8.

The water inlet 4 comprises a port, connectable in a known fashion to tubing or similar as part of a water purification unit. The water inlet 4 is optionally separable therefrom to allow a service engineer to replace the water purifying apparatus 2 in a water purification unit for maintenance or repair, in a manner known in the art.

The water inlet 4 connects to an inlet end cap 10, having a circular receiving portion for one end of the UVC radiation chamber 6.

The water purifying apparatus 2 shown in FIG. 2 shows a first sinter filter 12 located within the inlet end cap 10, at a position between the water inlet 4 and the UVC radiation chamber 6. In this way, the sinter filter 12 creates an ante-chamber 14 within the inlet end cap 10. The ante-chamber 14 creates an inlet area from the water inlet 4 extending across the width of the UVC radiation chamber 6, for the more even distribution of water against the inlet side of the sinter filter 12. The sinter filter 12 provides, due to its reduced porosity, a more controlled flow of water from its inlet side to its outlet side, thereby providing a more laminar flow of water into the UVC radiation chamber 6. In this way, the water more evenly approaches the UVC light or radiation transmitted into the UV radiation chamber 6, so that the UVC light has more effect thereon than radiating into a turbulent water flow.

The UVC radiation chamber 6 is an elongate cylinder, optionally internally coated with a reflective material such as PTFE, in order to reflect the incident light back into the radiation chamber. Optionally it may be coated with a material such as titanium dioxide that when the UVC reaches the material oxidising species are generated.

At the outlet end of the UVC radiation chamber 6, there is an outlet end cap 16 which includes or incorporates the water outlet 8.

The water purifying apparatus 2 includes a UVC assembly 18, comprising a printed circuit board having a series of UVC-LEDs thereon, described in more detail hereinafter, on top of which is located a heat sink 20 and a fan 22. One or more of the heat sink 20 and the fan 22 can be supported or housed by a suitable support cap 24, which can couple with the outlet end cap 16 in any suitable manner. FIG. 2 shows coupling via a screw thread, allowing easy operation, and access by a service engineer to the UVC assembly 18, heat sink 20 and/or fan 22, for easy maintenance or repair or replacement thereof. The UVC assembly is separated from the radiation chamber by a quartz glass disc 19, through which the UVC passes.

FIG. 3 shows the circular cross-section of the UVC radiation chamber 6, and the outlet end cap shown in FIG. 2. FIGS. 2 and 3 also show a series of radial or lateral apertures 26 located around the outlet end of the UVC radiation chamber 6, and able to pass water exiting the UVC radiation chamber 6 into an annular channel 28 within the outlet end cap 16, and also fluidly connected to the outlet 8. In this way, a multiple of outlet ports or portals in the form of apertures at the end of the UVC radiation chamber 6 provides a more laminar exit flow or outlet of water from the UVC radiation chamber 6, increasing the laminar flow of water generally within the UVC radiation chamber 6, especially closer to the UVC-LEDs of the UVC assembly 18. Such outlet water is then collected in the annular channel 28 to pass out as a singular outflow stream through the outlet 8 in a manner known in the art.

The outlet 8 may be connectable to suitable tubing or another part of a water purification unit, in the same manner as described hereinabove in relation to the water inlet 4.

FIGS. 4, 5 and 6 show first, second and third configurations of a UVC assembly usable in the apparatus of FIGS. 1 and 2.

FIG. 4 shows a first UVC assembly comprising a printed circuit board 34 on which are located six UVC-LEDs 32, located in a circular and symmetrical arrangement around the generally circular printed circuit board 34. The circuit board 34 includes two cut-outs 36 to help locate the printed circuit board 34 against lugs either within the outlet end cap 16, or within the support cap 24, so as to properly place the UVC assembly 30 at the right distance in relation to the UV radiation chamber 6 in use.

The nature of the UVC-LEDs 32 in FIG. 4 is known in the art, and is not further described herein. The skilled man is aware of a range of possible UVC-LEDs that are able to provide the required UVC radiation, generally adapted to emit light in the UV-C wavelength range of 220 nm-300 nm, preferably at or near 266 nm.

Next to each UVC-LEDs 32 is a temperature monitor or sensor 40, such as a thermistor, having a construction known in the art. The position and layout and use of the UVC-LEDs 32 and the temperature sensors 40 is shown in more detail in FIGS. 7a and 7b.

FIG. 4 shows the six UVC-LEDs 32 in an array on the printed circuit board 34. In the first configuration shown in FIG. 4, the UVC-LEDs 32 are alternatively labelled “A” and “B”, so as to form a circular pattern of ‘ABABAB’, which can be divided into two sets of UVC-LEDs, each set being symmetrical. The A-labelled UVC-LEDs form a set of ‘first’ UVC-LEDs, and the B-labelled UVC-LEDs form a set of second UVC-LEDs.

In the arrangement shown in FIG. 4, a control (not shown) can be used to alternate the use of the UVC-LEDs 32. For example, the control can be used to operate those UVC-LEDs labelled A, and then to cease or stop the use of the A-labelled UVC-LEDs 32, and start use or operation of the UVC-LEDs 32 labelled B. In this way, the control alternates the use of the A set and B set of UVC-LEDs.

Whilst UVC-LEDs are known to be more beneficial than fluorescent tubes in providing UVC light, UVC-LEDs also have some issues, in particular heating and maintaining efficiency over time.

In an arrangement of using alternate sets of UVC-LEDs as shown in FIG. 4, the water purification apparatus is able to operate the alternate sets to reduce or avoid the need for continuous operation of UVC-LEDs in a water purification apparatus. With reduced operation, such as through alternative and therefore intermittent use as shown in FIG. 4, the requirement for the dissipation of heat from operational UVC-LEDs can be eased. And with reduced operation, the expected fading of the efficiency of a UVC-LED by the continuous use thereof is a reduced issue, allowing for expected longer life of the UVC-LEDs, and therefore expected longer use of the water purifying apparatus without servicing or replacement.

In the configuration shown in FIG. 4, it is assumed, by way of example only, that the amount of UVC light or radiation required to achieve the expected effect to the capacity of the UVC radiation chamber 6, can be achieved by the use of three of the UVC-LEDs 32. The skilled man can see that the printed circuit board 34 can accommodate either more or less UVC-LEDs, and that the present invention is operable with either less or more UVC-LEDs, and that the UVC-LEDs can be divided into a range of different sets, such as 4×2, 2×4, 3×2, 2×3, etc.

In the configuration shown in FIG. 4, an aging monitor can be used to monitor the UVC output of each of the UVC-LEDs 32, and when one or more of a first set are considered to be providing insufficient UVC radiation to achieve the expected effect into the UVC radiation chamber 6, one or more of the other set of UVC-LEDs could be initiated or started to provide sufficient UVC into the UVC radiation chamber 6. The selection of the additional UVC-LED may be defined, sequential or random.

FIG. 5 shows a second configuration of a UVC assembly 50, comprising a printed circuit board 34a, on which there is located a number of UVC-LEDs 32 in the same physical array as that shown in FIG. 4.

In FIG. 5, there is shown a first set of four first UVC-LEDs labelled “A”, in a symmetrical arrangement, and a second set of two secondary/back-up/second/reserve UVC-LEDs labelled “C”. In the configuration shown in FIG. 5, it is assumed, by way of example only, that the amount of UVC light or radiation required to achieve the expected effect to the capacity of the UV radiation chamber 6, can be achieved by the use of four of the UVC-LEDs 32. A control (not shown) in the configuration shown in FIG. 5 only requires the simultaneous operation of the UVC-LEDs 32 labelled A. The first and second UVC-LEDs 32 if used together, would provide more UV light than required for the capacity of the UVC radiation chamber 6.

As mentioned above, UVC-LEDs are known to lose some of their efficiency over time, generally by emitting a reduced amount of UVC radiation over time, especially if run continuously.

In the configuration shown in FIG. 5, an aging monitors can be used to monitor the UVC output of each of the set A of first UVC-LEDs 32, and when one or more of said set A are considered to be providing insufficient UVC radiation to achieve the expected effect into the UVC radiation chamber 6, that or each of the first UVC-LEDs 32 could be stopped or switched off, and one or more of the secondary/back-up/second/reserve UVC-LEDs labelled C could be initiated or started.

In this way, FIG. 5 shows a second configuration whereby there is provided two reserve UVC-LEDs, able to be brought into operation following the failure of one or two of the set A first UVC-LEDs 32, to allow continuance of the operation of the water purifying apparatus 2 beyond the lifespan of at least a first and at least a second of the initial UVC-LEDs in use.

Optionally, the water purifying apparatus 2 can include one or more warnings or alarms, being either electrical, aural, and/or visual, to provide a user or a service engineer with a warning that there has been a failure of at least one of the first UVC-LEDs, and that whilst the water purifying apparatus 2 can continue by the use of one or more of the reserve UVC-LEDs, it is an appropriate time to consider servicing the water purifying apparatus 2 in the near future. This allows operation of the water purifying apparatus 2 to continue for a time period thereafter, rather than having any catastrophic or dramatic break in operation, which may result in stoppage of the overall system or unit for providing water purification.

A third configuration of a UVC assembly 60 is shown in FIG. 6, having six UVC-LEDs 32 on a printed circuit board 34b in the same array as shown in FIG. 4, but now labelled into three sets of A, B and C, of two UVC-LEDs each. In a combination of the first and second configurations described hereinabove, the third configuration shown in FIG. 6 could involve a control (not shown) alternating between a set A of first UVC-LEDs, a set B of second UVC-LEDs, and having two reserve UVC-LEDs being set C. In this way, there are provided the benefits of both the first and second configurations shown in FIGS. 4 and 5, in that there is not continuous use of any of the UVC-LEDs, along with having reserve UVC-LEDs able to continue the operation of the water purifying apparatus following the failure, either dramatic or over time, of one of the UVC-LEDs in the primary sets, being labelled A or B in FIG. 6.

The skilled man can see that the present invention, by providing a number of UVC-LEDs able to provide an amount of UVC light which is greater than UV light required for the capacity of the UVC radiation chamber, can achieve extended lifetime or extended continuous operation of the water purifying apparatus, whilst allowing or providing some warning to the user or service engineer for the need to repair or replace either the UVC assembly or the water purifying apparatus itself, at a more convenient time than when it is required to provide purified water.

FIGS. 4-6, and in particular FIG. 7a, also shows the location of a temperature sensor 40 near to each of the UVC-LEDs 32, which temperature sensors 40 can monitor the heat dissipation of the neighbouring UVC-LED. Optionally, each of the temperature sensors 40 is connected to a control (see FIG. 7b), able to operate and vary the use and/or power provided to the UVC-LEDs 32. The information from the temperature sensors 40 along with information about the voltage and/or current being applied to each UVC-LED can be used by the control system to determine the status of each UVC-LED and the water purifying apparatus as a whole. The control system can then be adapted to provide a warning, either electrical, aural or visual, to a user and/or service engineer where the temperature of a UVC-LED goes above or below a certain value or threshold, or starts to change in a non-expected way. This allows the control system, a user or service engineer to modify operation or control of any or all of the UVC-LEDs 32 to achieve a continuance of the water purifying apparatus for an extended time until repair and/or replacement is more convenient while able to maintain continuation or continuance of the intended water purifying effect within the UVC radiation chamber 6.

FIG. 7b shows only one of the UVC-LEDs 32 on the printed circuit board 34 for clarity, and its associated or neighbouring temperature sensor 40 as part of an overall aging monitor 42. The UVC-LED 32 is powered from a power supply via suitable connections on a separate location such as a board 41, from which a power characteristic such as voltage, current, or both, can be monitored by a suitable voltmeter 46 and ammeter 48, etc., and information passed to a microprocessor control 44. The temperature sensor 40 can also relay information to the microprocessor 44, to allow the microprocessor 44 to understand/monitor/control operation of the UVC-LED 32 as described herein.

FIGS. 8 and 9 show two water purifying systems incorporating the water purifying apparatus, which can each provide an overall water purification unit.

FIG. 8 shows a first water purification system 100 incorporating water purifying apparatus 102. A water to be purified enters the water purification system 100 through water inlet 104 and is passed in turn through pre-filter 106 that removes particles and chlorine from the water; boost pump 108 that increases the pressure of the water; reverse osmosis membrane 110 that removes ions and organic molecules from the water and degassing membrane 112 that removes dissolved gases including carbon dioxide from the water before passing the water to reservoir 114 in a manner known in the art. The reservoir 114 includes vent filter 116 that removes particles, bacteria and carbon dioxide from air entering the reservoir 114 when the water level in the reservoir is reduced by operation of downstream processes and user demand. Water from the reservoir 114 is passed around a recirculation loop by pump 118 re-entering the reservoir at inlet 128 if not required by a user. After the pump 118 the water is passed through an ion exchange pack 120 to remove remaining ions including carbon dioxide; the UVC-LED water purifying apparatus 102 and a final fine filter 122 such as a micro-filter or ultra-filter to remove de-activated bacteria and organic molecules to an external loop (not shown) that passes from the ultra-purified water outlet 124 of the water purification system 100 around the laboratory or similar to take off points as the user desires, unwanted water returning back to the ultra-purified water inlet 126 for return to the reservoir 114.

The water purification system 100 can be operated such that when purified water is entering the reservoir from the inlet stream 104 the UVC-LEDs 32 are operated in a boost state, either with more UVC-LEDs 32 operated or operation at a higher power. Operation of extra UVC-LEDs may be using defined extra UVC-LEDs or using random extra UVC-LEDs.

FIG. 9 shows a second water purification system 200 with similar features to the first water purification system 100 except that the second water purification system has an outlet such as a tap or faucet 224 for dispense of ultra-purified water. ‘Undispensed’ water is returned to the reservoir by line 226 and valves for operation of such system is known. Tap or faucet 224 includes one of more point of use UVC-LEDs to act a final treatment of the water. Operation of the point of use UVC-LEDs in tap or faucet 224 is by controller 230 that also controls the operation of the UVC-LEDs in the UVC-LED water purifying apparatus 202. It is preferable for most of the UVC to be applied in the water purifying apparatus 202 with the energy applied in the tap or faucet 224 being <50%, preferably <20%, of that applied in the water purifying apparatus 202.

### EXAMPLE 1

A water purifying apparatus as shown in FIG. 1 with a set of three first UVC-LEDs and a set of three second UVC-LEDs was fed with water containing 380 CFU/100 ml. The set of first UVC-LEDs were operated for 3 seconds before being turned off, at which time the set of second UVC-LEDs were then operated for 3 seconds before being turned off: operation of the UVC-LEDs continuing in this alternating sequence. The water exiting the water purifying apparatus was measured for bacterial content and a log10 reduction of 1.93 was observed.

### EXAMPLE 2

A water purification system as shown in FIG. 8, containing a water purifying apparatus as shown in FIG. 1, was fed with potable mains water and operated for 2 months. The water purifying apparatus contained a set of three first UVC-LEDs and a set of three second UVC-LEDs. When potable mains water was passed into the reservoir the UVC-LEDs were operated in sequence with each set of UVC-LEDs operated for 3 seconds and then were off for 3 seconds while the other set was operated. During periods when the water in the reservoir was being recirculated around the recirculation loop without any water coming into the reservoir from the RO and degassing membrane, the sets of UVC-LEDs were each operated for 3 seconds on and 17 seconds off, such that the water was exposed to UVC light 3 seconds in every 10 seconds. The ultra-purified outlet water exiting the unit was dispensed at 50 litres per day and regularly monitored for bacterial content. All samples analysed were found to have <1 CFU/ml of bacteria.

The present invention provides a water purifying apparatus able to have a number of advantages and benefits, to improve the efficiency and/or continuance of the water purifying apparatus in order to purify a water stream entering through the water inlet 2, and exiting the apparatus through the water outlet 8. The skilled man can see that the water purifying apparatus shown in the figures can include more than one inlet, and more than one outlet, and that other variations and embodiments are possible within the scope of the present invention and the variants described herein.

Further aspects and embodiments of the present invention include, individually, separately and/or in combination,

A water purifying apparatus comprising:
at least one water inlet;
an ultra-violet C (UVC) radiation chamber;
two or more UVC light emitting diodes (UVC-LEDs) for the emission of UVC light into the radiation chamber; and
at least one water outlet,

characterised in that the apparatus further comprises a control to alternate the use of the UVC-LEDs.

A water purifying apparatus comprising:
at least one water inlet;
an ultra-violet C (UVC) radiation chamber;
two or more UVC light emitting diodes (UVC-LEDs) for the emission of UVC light into the radiation chamber; and
at least one water outlet,

characterised in that the apparatus further comprises at least one aging monitor of the UVC-LEDs.

A water purifying apparatus comprising:
at least one water inlet;
an ultra-violet C (UVC) radiation chamber;
two or more UVC light emitting diodes (UVC-LEDs) for the emission of UVC light into the radiation chamber; and
at least one water outlet,

characterised in that one water outlet comprises a series of apertures in the radiation chamber, and an endcap able to fit around the apertures to create a collection annulus between the radiation chamber and the endcap to direct water flow from the radiation chamber through the apertures to the collection annulus and therefrom to a single outlet stream.

A water purifying apparatus comprising:
at least one water inlet;
an ultra-violet C (UVC) radiation chamber;
two or more UVC light emitting diodes (UVC-LEDs) for the emission of UVC light into the radiation chamber; and
at least one water outlet,

characterised in that the apparatus further comprises a sinter filter between the at least one water inlet and the UVC radiation chamber, or between the UVC radiation chamber and the at least one water outlet, or both.

A water purifying apparatus comprising:
at least one water inlet;
an ultra-violet C (UVC) radiation chamber;
two or more UVC light emitting diodes (UVC-LEDs) on a PCB for the emission of UVC light into the radiation chamber; and
at least one water outlet,

characterised in that the PCB is at least partially reflective to direct UVC light into the radiation chamber.

A water purifying apparatus comprising:
at least one water inlet;
an ultra-violet C (UVC) radiation chamber;
a set of two or more first UVC light emitting diodes (UVC-LEDs) for the emission of UVC light into the radiation chamber; and
at least one water outlet,

characterised in that the apparatus further comprises a set of one or more second UVC-LEDs, which together with the first UVC-LEDs, are able to provide more UVC radiation into the UVC radiation chamber than required for the capacity of the radiation chamber, and a control to limit the simultaneous operation of the number of the UVC-LEDs.

Such further aspects and embodiments may further include one or more of the following:
wherein the UVC-LEDs are located on an electrical circuit board, such as a printed circuit board or PCB, optionally being at least partially reflective.
wherein the UVC-LEDs are located in an array.
comprising 2-12 UVC-LEDs, optionally, 4-8 UVC-LEDs such as 6 UVC-LEDs.
wherein an aging monitor is located next to each UVC-LED.
comprising an elongate UVC radiation chamber, optionally a cylindrical ultra-violet UVC radiation chamber.
wherein the UV radiation chamber is partially, substantially or wholly internally coated with Teflon or PTFE.
wherein the UVC-LEDs are arranged in to at least two sets of UVC-LEDs, and wherein the control alternates the use of each set of UVC-LEDs.
wherein the UVC-LEDs are arranged in two or three sets of UVC-LEDs, and wherein the control alternates the use of each set of UVC-LEDs.
wherein the one water outlet comprises a series of radial or lateral apertures in the radiation chamber, and an endcap able to fit around the apertures to direct water flow to a single outlet port.
wherein a sinter filter is located after the at least one water inlet.
wherein a sinter filter is located before the at least one water outlet.
Wherein the control is able to vary the use of at least a number of the UVC-LED, such as the power of at least a number of the UVC-LED.
wherein the control is able to increases the power of at least one or more of the UVC-LED over time, optionally all of the UVC-LEDs over time.
wherein the apparatus comprises a water inlet, a water outlet, and a cylindrical UVC radiation chamber thereinbetween.
having the UVC-LEDs located on an electrical circuit board at one end of the cylindrical UVC radiation chamber.
having the UVC-LEDs located on an electrical circuit board at one end of the cylindrical UVC radiation chamber beyond the water outlet.
having an antechamber after the water inlet and before cylindrical UVC radiation chamber.
wherein a sintered filter is located in or as part of the antechamber, or between the antechamber and the radiation chamber.
comprising a plurality of operational UVC-LEDs and at least one support UVC-LED, wherein the control is able to operate at least one support UVC-LED upon the failure of any of the operational UVC-LEDs.
comprising activating a UVC-LED from a set of UVC-LEDs that would not otherwise be operating at that time when the failing UVC-LED would be operating.
comprising a water purifying apparatus further comprising one or more of the group comprising; pumps, meters, oxidisers, de-ionisers, valves, sensors, drains, controllers, control units and mechanisms, taps, filters, membranes; and able to provide a purified water stream having a conductivity of less than 1 μS/cm, preferably less than 0.1 μS/cm at 25° C. and an organic species content of less than 500 ppb of total organic carbon (TOC), preferably less than 50 ppb.

1. A water purifying apparatus comprising:
(i) at least one water inlet;
(ii) an ultra-violet (UVC) radiation chamber connected to the water inlet(s);
(iii) a plurality of UVC light emitting diodes (UVC-LEDs) for the emission of UVC light into the radiation chamber;
(iv) a control to operate UVC-LEDs in use; and
(v) at least one UVC-LED aging monitor to provide feedback to the control.

2. A water purifying apparatus as claimed in claim 1 wherein the UVC-LEDs are located on an electrical circuit board.

3. A water purifying apparatus as claimed in claim 1 wherein the UVC-LEDs are located in an array.

4. A water purifying apparatus as claimed in claim 1 comprising 2-12 UVC-LEDs.

5. A water purifying apparatus as claimed in claim 1 wherein the UVC-LEDs are arranged in to at least two sets of UVC-LEDs, being at least a set of first UVC-LEDs and a set of second UVC-LEDs.

6. A water purifying apparatus as claimed in claim 5 comprising a first set of three first UVC-LEDs and a second set of three second UVC-LEDs.

7. A water purifying apparatus as claimed in claim 5 wherein the control is able to alternate the use of each set of UVC-LEDs.

8. A water purifying apparatus as claimed in claim 5 wherein the control is able to switch the use of one of the set of first UVC-LEDs to one of the set of second UVC-LEDs upon failure of one of the first UVC-LEDs.

9. A water purifying apparatus as claimed in claim 1 wherein the control is able to vary the use of at least a number of the UVC-LED.

10. A water purifying apparatus as claimed in claim 1 wherein the control is able to vary the power of at least a number of the UVC-LED.

11. A water purifying apparatus as claimed in claim 1 wherein the control is able to increase the power of at least one or more of the UVC-LEDs over time.

12. A water purifying apparatus as claimed in claim 1 wherein an aging monitor is located next to each UVC-LED.

13. A water purifying apparatus as claimed in claim 1 wherein the or each aging monitor monitors at least temperature and a power characteristic of an UVC-LED.

14. A water purifying apparatus as claimed in claim 1 wherein the or each aging monitor is able to monitor the operational lifetime of an UVC-LED.

15. A water purifying apparatus as claimed in claim 1 wherein an aging monitor is able to feedback the failure of UVC-LED to the control.

16. A water purifying apparatus as claimed in claim 1 comprising a cylindrical UVC radiation chamber.

17. A water purifying apparatus as claimed in claim 1 further comprising a reflective surface behind the UVC-LEDs.

18. A water purifying apparatus as claimed in claim 1 having the UVC-LEDs located on an electrical circuit board at or near one end of the cylindrical UVC radiation chamber.

19. A water purifying apparatus as claimed in claim 1 further comprising a series of apertures in the UVC radiation chamber, and an endcap able to fit around the apertures to create a collection annulus between the radiation chamber and the endcap to direct water flow from the radiation chamber to a single outlet stream.

20. A water purifying apparatus as claimed in claim 1 further comprising one or more UVC-LEDs able to provide more UVC radiation into the UV radiation chamber than required to treat the maximum fluid capacity of the radiation chamber;

21. A water purifying apparatus as claimed in claim 1 further comprising a sintered filter between the at least one water inlet and the UVC radiation chamber.

22. A water purifying apparatus as claimed in claim 1 having an antechamber after the water inlet and before cylindrical UVC radiation chamber.

23. A water purifying apparatus as claimed in claim 22 wherein a sintered filter is located between the antechamber and the radiation chamber.

24. A water purifying unit comprising one or more water dispense outlets, a water purifying apparatus as claimed in claim 1, and further comprising one or more selected from of a group comprising pumps, meters, oxidisers, de-ionisers, valves, sensors, drains, controllers, control units and mechanisms, taps, filters, membranes; and able to provide a purified water stream having a conductivity of less than 1 μS/cm at 25° C. and an organic species content of less than 500 ppb of total organic carbon (TOC).

25. A water purifying unit as claimed in claim 24 further comprising one or more UVC-LEDs located at or around a point of dispense of one of the water dispense outlets.

26. A water purifying unit as claimed in claim 25 wherein the total power applied to the one or more UVC-LEDs located at or around the point of dispense is <50% of the total power applied to all of the operational UVC-LEDs in the water purifying apparatus.

27. A system for facilitating maintenance of water treatment apparatus as claimed in claim 1 comprising the steps of:
a. providing multiple UVC-LEDs;
b. operating at least one of the UVC-LED;
c. monitoring the usage of each operational UVC-LED;
d. determining the operational life of each operational UVC-LED; and
e. when the end of the operational life of a UVC-LED is determined, switching the said UVC-LED to another UVC-LED.

28. A method of providing purified water comprising at least the steps of:
passing water through a water purifying apparatus as defined in claim 1.

29. A method as claimed in claim 28 further comprising controlling the alternate use of UVC-LEDs.

30. A method as claimed in claim 28 further comprising the steps of:
noting a failing UVC-LED; and
activating a previously unused UVC-LED to replace the failing UVC-LED.

31. A method as claimed in claim 1 further comprising varying the use of one or more of the UVC-LEDs.

32. A method as claimed in claim 1 further comprising increasing the power of at least one or more of the UVC-LEDs over time

33. A method as claimed in claim 1 wherein the apparatus comprises a plurality of UVC-LEDs able to provide more UVC radiation into the UVC radiation chamber than required to treat the maximum fluid capacity of the radiation chamber, the method further comprising limiting the simultaneous operation of the number of the UVC-LEDs.

34. A method as claimed in claim 33 wherein the apparatus comprises at least a set of two or more first UVC-LEDs, and a set one or more second UVC-LEDs, which together with the first UVC-LEDs, are able to provide more UVC radiation into the UVC radiation chamber than required to treat the maximum fluid capacity of the radiation chamber, the method further comprising limiting the simultaneous operation of the number of the UVC-LEDs.

35. A method as claimed in claim 1 wherein the aging monitor detects operational failure of one or more of the UVC-LEDs and provides feedback to the control, and wherein the control operates one or more UVC-LEDs to change the operation of one or more UVC-LEDs based upon the feedback.
